(19) United States
(12) Patent Application Publication
(10) Pub. No.: US 2010/0332792 A1
(43) Pub. Date: Dec. 30, 2010

(54) Integrated Vector-Scalar Processor

(75) Inventor: Daniel B. CLIFTON, Chuluota, FL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Advanced Micro Devices, Inc., Sunnyvale, CA (US)

(21) Appl. No.: 12/495,246

(22) Filed: Jun. 30, 2009

(51) Int. Cl. G06F 15/76; G06F 9/06

(52) U.S. Cl. 712/4; 712/9; 712/E09.003

(57) ABSTRACT

Systems and methods for improved vector data processing based on separately processing elements of a vector in multiple simultaneously executing vector element processing units are disclosed. One embodiment of the present invention is a vector processing system including a plurality of vector element processing units and a routing infrastructure. The routing infrastructure is configured to route each element of a received vector to a respective one of the vector element processing units. The received vector may be from a memory which is coupled to the vector element processing units by the routing infrastructure. Each vector element processing unit is configured to simultaneously process two or more elements, wherein each of the two or more elements is from a separate vector. Embodiments of the present invention also provide for forwarding of data and results of computation between vector element processing units.

### BACKGROUND OF THE INVENTION

1. Field of the Invention

The present invention relates generally to the processing of vector data.

2. Background Art

Some types of data processing, such as processing of pixel data or vertex data in graphics applications, are well suited for vector processing. A processor, such as a central processor unit (CPU) or a graphics processor unit (GPU) can have one or more vector processing units and/or one or more scalar processing units. A vector processing unit can, in general, execute an instruction on multiple data elements. In contrast, a scalar processing unit operates only on one data element at a time.

Vector processing is well suited for applications having a high degree of parallelism such as graphics processing applications. GPUs, in particular, generally include multiple vector processing units. For example, in a graphics processing application, each pixel and/or each vertex can be represented as a vector of elements. The elements of a particular pixel can include the color values such as red, blue, green, and an opacity value (e.g., R,B,G,A). The elements of a vertex can be represented as position coordinates X, Y, and Z. Vertices are often represented with the position coordinates together with a fourth parameter used to convey additional information—X,Y,Z,W. Numerous other representations of data, including vertex and pixel data, as vectors are possible.

Processing efficiency, power consumption, and processor size, are some aspects that can be affected by the design and layout of the vector processing units. Properly scheduled instructions executed on vector processing units can generally reduce overall application execution times substantially. Improvements in the design and layout of vector processing units can lead to substantial gains in processor performance, and substantial reductions in the amount of logic in a processor, thus reducing the size of the processor, its cost and its power consumption.

What are needed, therefore, are methods and systems to improve the design of vector processing units.

### BRIEF SUMMARY OF THE INVENTION

Systems and methods for improved vector processing are disclosed. One embodiment of the present invention is a vector processing system including a plurality of vector element processing units, and a routing infrastructure coupled to the plurality of vector element processing units. The routing infrastructure is configured to route each element of a received vector to a respective one of vector element processing units. Embodiments of the present invention also provide for forwarding of data and results of computation between vector element processing units. Yet other embodiments enable the flexible substitution of elements of a vector with constants or scalar values prior to that vector being submitted for processing in a vector engine.

Another embodiment is a method of processing a plurality of vectors by routing each element of a vector to a separate vector element processing unit of a plurality of vector element processing units, wherein the vector is from the plurality of vectors, processing said each element respectively in said separate vector element processing unit, and outputting at least one result from said separate vector element processing units.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated in and constitute part of the specification, illustrate embodiments of the invention and, together with the general description given above and the detailed description of the embodiment given below, serve to explain the principles of the present invention. In the drawings:

FIG. 1 shows a computing system in accordance with an embodiment of the present invention.

FIG. 2 shows a vector data processing system in accordance with an embodiment of the present invention.

FIG. 3 is a flowchart illustrating vector data processing, according to an embodiment of the present invention.

FIG. 4 is a flowchart illustrating steps in routing of vector data to separate vector element computing units, according to an embodiment of the present invention.

FIG. 5 is a flowchart illustrating the processing in a vector element computing unit, according to an embodiment of the present invention.

FIG. 6 illustrates how elements of several data vectors are processed through vector element processing units, according to an embodiment of the present invention.

### DETAILED DESCRIPTION OF THE INVENTION

Embodiments of the present invention are directed to the design of improved vector processing units. For example, in one embodiment, a vector engine for a GPU is configured to process data such as pixel data in a novel manner. The vector engine, in the said embodiment, includes four vector element processing units. The novel manner in which the pixel data is made available to the individual vector element processing units, and the manner in which the vector elements are processed in the vector processing unit can result in substantial reductions in processor size and power consumption. It can also result in substantial gains in processing efficiency.

In many kinds of processors, such as GPUs, some application data is stored, accessed, and processed as vectors. In graphics applications, for example, vertex and pixel data are typically represented as vectors of several elements, such as, X, Y, Z, and w. The X, Y, Z, and W elements can represent various application parameters depending on the particular application. For example, in a pixel shader, X, Y, Z, and W can correspond to pixel elements such as the color components R, B, G and alpha or opacity component A. In an embodiment of the present invention, where a GPU comprises one or more shaders, the X, Y, Z, and W elements of successive vectors of pixel data are input to separate vector element processing units within a shader. In the following description, the term “vector element,” “pixel element,” or simply “element,” refers to one data component of a vector, such as, one of X, Y, Z, or W data components of a vector. Routing of pixel elements to the separate vector element processing units within a shader can be staggered such that intermediate or final processing results of a pixel element can be forwarded from a first vector element processing unit to a second vector element processing unit where another pixel element is being processed. This approach, when compared to the conventional approach of processing each vector corresponding to an individual pixel in a separate vector processing unit, can result in substantially reduced processing logic and/or routing infrastructure in the processing system. For example, according to a conventional approach, each vector processing unit is required to include logic necessary to process all four components of a pixel. The four components of a pixel can represent different aspects and hence require different processing logic. In embodiments of the present invention, each vector element processing unit can be optimized for the processing of a subset of the elements of the vectors to be processed. Embodiments of the present invention, also facilitate superscalar processing and integrated vector-scalar processing by, for example, enabling the multiplexing of one or more constants or scalar values to be processed in any of the vector element processing units.

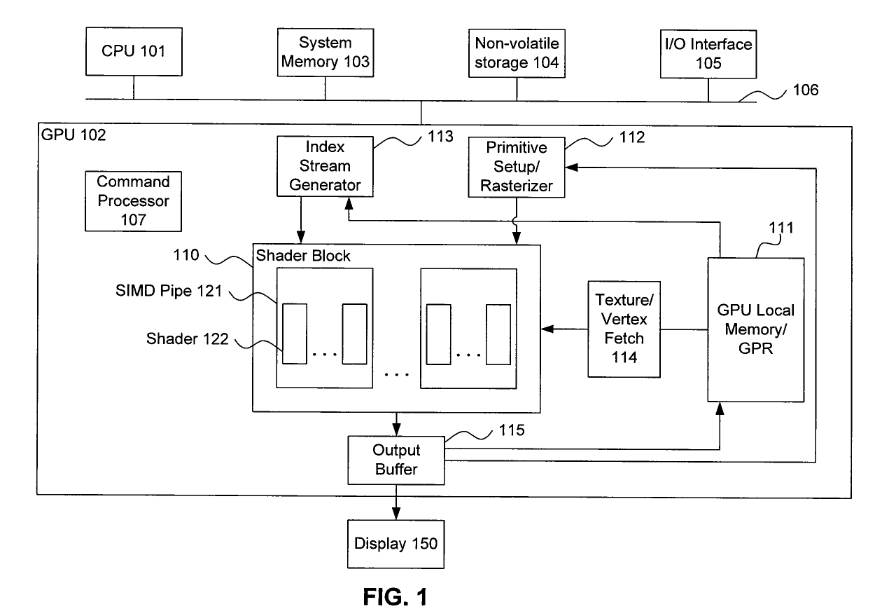

FIG. 1 illustrates a computer system 100 in accordance with an embodiment of the present invention. Computer system 100 includes at least one CPU 101, at least one GPU 102, at least one system memory 103, at least one non-volatile storage 104, at least one input/output interface 105, and at least one data communication bus 106. Computer system 100 can be coupled to a display 150. At least one CPU 101 can be a commercially available CPU, a digital signal processor (DSP), a field programmable gate array (FPGA), application specific integrated circuit (ASIC), or other custom processor. CPU 101 has overall control over the functions of computer system 100.

At least one GPU 102 includes functionality to execute graphics processing aspects of an application. For example, an application executing on CPU 101 can have graphics processing and display related instructions processed on GPU 102. GPU 102 can include a shader block 110, a GPU local memory 111, a primitive setup and rasterizer 112, an index stream generator 113, a texture/vertex fetcher 114, an output buffer 115, and a command processor 107. As will be understood by those of ordinary skill in the art, GPU 102 could be logic embedded in another device such as CPU 101, a bridge chip (such as a northbridge, southbridge or combined device) or the like.

Shader block 110 can be a unified shader or can include separately implemented vertex and pixel shaders. Shader block 110 can also include other shaders such as geometry or compute shaders. Without loss of generality, the description herein primarily uses pixel processing, i.e., processing of pixel data within a GPU such as GPU 102, to illustrate embodiments of the invention. In the following, the term “shader” is used to refer to a unified shader, vertex shader, and/or pixel shader as may be appropriate in the particular context. Shader block 110 can include one or more single instruction multiple data (SIMD) pipes 121. Each SIMD pipe 121 can include one or more shaders, and each shader can include a vector engine and a scalar engine. Each shader includes logic to process an incoming stream of vectors, such as vector or pixel data. A vertex shader can, for example, receive three-dimensional object position information, texture coordinates, normal vectors, and color information. A vertex shader can be used to perform transformation operations on position data, which typically consists of four 32-bit values for each vertex (X, Y, Z co-ordinates, and a W co-ordinate for calculating perspective).

Pixel shaders typically encounter color data in RGBA (Red/Green/Blue/Alpha) or like format. Pixel data in RGBA format, for example, includes three color values (RGB), and a transparency value (A). In one embodiment, shader block 110 of GPU 102 can include three SIMD pipes, where each SIMD pipe includes 16 shaders, and where each shader includes a vector engine with four vector element processing units and a scalar engine.

GPU local memory 111 can include a volatile memory such as static random access memory (SRAM) or dynamic random access memory (DRAM). GPU local memory 111 can also include one or more general purpose registers (GPR). GPU local memory 111 can be used to hold input data, intermediate data, as well as output data for processing by GPU components such as shader block 110. For example, a set of general purpose registers in GPU local memory 111 may be reserved for receiving vertex data from a system memory and holding the data until a vertex shader from shader block 110 is ready to process that vertex data.

Primitive setup and rasterizer 112 may include one or more processing components and includes the functionality to perform graphics processing functions such as, but not limited to, setting up of primitives such as vertices of an image, clipping an image, and rasterizing an image. In setting up primitives, for example, primitive setup and rasterizer 112 can assemble the vertices processed by a vertex shader to triangles and associate such triangles with textures and tiles as needed. Primitive setup and rasterizer 112 can also control the flow of vertex and pixel data that flow into shader block 110.

Index stream generator 113 includes the functionality to provide shader block 110 with a vertex stream and/or indices indicating how vertices are to be assembled. Texture/vertex fetcher 114 includes the functionality to fetch vertex data and texture data from system memory 103 and store in GPU local memory 111 for use in shader block 110.

Output buffer 115 can hold processed vertices and/or pixels output from shader block 110. Data temporarily stored in output buffer 115 can be transmitted to one or more other devices, such as, for example, display 107, primitive setup and rasterizer 112, or GPU local memory 111.

Command processor 107 can receive instructions to be executed on GPU 102 from CPU 101. Command processor 107 includes the functionality to interpret commands received from CPU 101 and to issue the appropriate instructions to execution components of the GPU, such as, components 110, 112, 113, or 114. For example, upon receiving an instruction to render a particular image on display 150, command processor 107 issues one or more instructions to cause components 110, 112, 113, or 114 to render that image. Vertex data from system memory 103 can be brought into general purpose registers in GPU local memory 111 and the vertex data can then be processed in a shader in shader block 110. Command processor 107 can issue the corresponding vector instructions to process the vertex data in the shader from shader block 110.

System memory 103 is generally used to hold instructions and data for use by CPU 101 in the execution of applications. Data stored in system memory 103 during the execution of an application can be moved to GPU local memory 111 for processing in GPU 102, for example, in the rendering of images on display 107. System memory 103 can include dynamic random access memory (DRAM) or such volatile memory.

Non-volatile storage 104 can include one or more storage devices such as hard disk, optical disk, flash memory, and the like. Non-volatile storage 104 can be used to store application program code and data prior to the execution of such code in CPU 101 and/or GPU 102.

Input/output interface 105 provides functionality to receive input to computer system 100 and to provide output from computer system 100. For example, input/output interface 105 can receive user input and/or application code to be executed.

Embodiments of the present invention may be used in any computer system, computing device, entertainment system, media system, game systems, communication device, personal digital assistant, or any system using one or more processors. The present invention is particularly useful where the vector processing can be advantageously utilized.

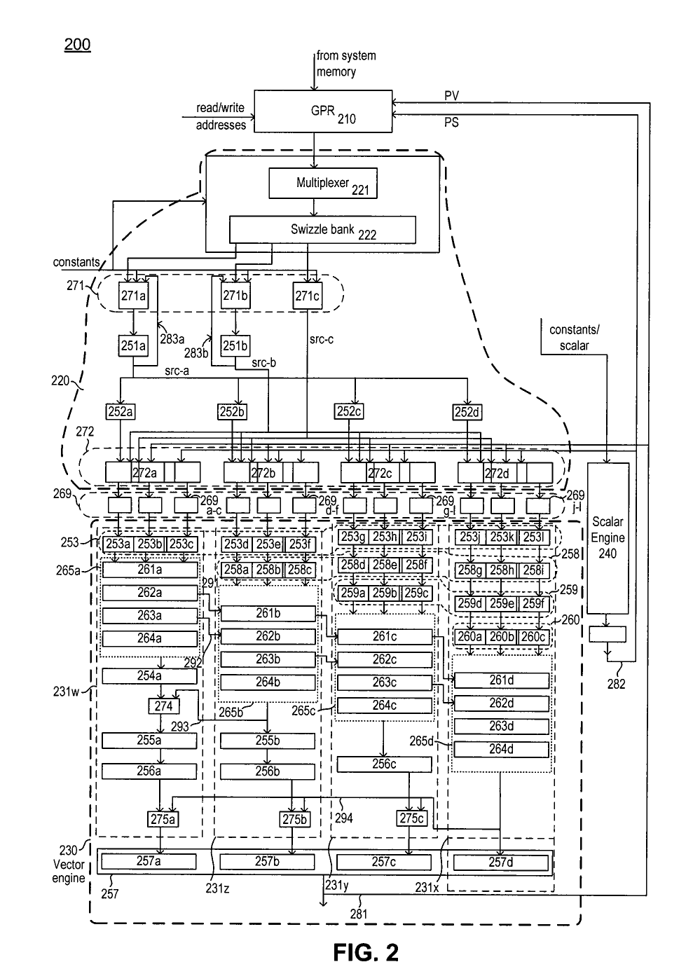

FIG. 2 illustrates a shader 200, according to an embodiment of the present invention. Shader 200 can be one of the shaders 122 shown in FIG. 1. For example, in one embodiment, shader block 110 of computer system 100 can include 16 SIMD pipes with each SIMD pipe including 4 shaders. Shader 200 can, for example, be one of the shaders in a SIMD pipe 121. Shader 200 can include a GPR bank 210, a routing infrastructure 220, a vector engine 230, and a scalar engine 240.

GPR bank 210 can include one or more GPRs. GPR bank 210 can also include of memory components such as DRAM and/or GPU local memory 111. Without loss of generality, the following description refers to register memory in GPR bank 210. During execution of an application in a computer system that includes shader 200, one or more registers in GPR bank 210 would store vertex and/or pixel data for processing in shader 200. GPRs can be organized in numerous ways to enable efficient use of GPR space and efficient access to the data contained therein. In some embodiments, GPR bank 210 can be organized according to one more ring buffer structures or the like that facilitates simultaneous or near-simultaneous access to write incoming data and to read outgoing data. For example, vertex data from a system memory may be loaded to a set of registers, while simultaneously vertex data is read out of another set of registers for processing by a vertex shader. Vertex data can be maintained in one ring buffer for processing by vertex shaders, while pixel data output by vertex processors can be stored in another ring buffer. Each ring buffer or other structure in GPR bank 210 can be further organized to efficiently access vector data stored therein. When pixel data is stored as vectors, GPR bank 210 can provide the ability to simultaneously, but separately, access all components of the pixel data vector. For example, considering a 128 bit pixel data vector to have X, Y, Z, and W components, each 32 bits, GPR bank 210 may include functionality to provide simultaneous separate read access to the X, Y, Z, and W, components of one or more pixels. GPR bank 210 can also include functionality to multiplex values separately on write to one or more of the register locations corresponding to the X, Y, Z, or W components. For example, each 32 bit register may have as associated multiplexer. The multiplexer associated with each register can be programmed to enable the writing to that register of an input value selected from among incoming pixel data from system memory or vector or scalar data written back to GPR bank from processing engines 230 and/or 240.

Routing infrastructure 220 includes the functionality to route data from GPR bank 210 to processing engines 230 and 240. Routing infrastructure 220 can include one or more multiplexers (e.g., multiplexers 221, 271, 272), one or more swizzle units (e.g., swizzle units 222), and data registers (e.g., 251a-b, 252a-d). Each shader can have four multiplexers coupled between GPR bank 210 and swizzle unit bank 222. The four multiplexers can be configured to read from GPR bank 210, and then deliver to swizzle units 222, the four elements of a pixel selected to be processed next. Swizzle unit 222, in coordination with coupled multiplexers 221, route components towards a corresponding vector element processing units and/or scalar engine, as appropriate. The swizzle units can be configured to change the ordering of elements in a vector. In subsequent processing described below, a source data may not correspond to an original source pixel retrieved from GPR 210 because elements can be swizzled and/or multiplexed before entering the respective vector element processing units. The ability to swizzle and/or multiplex data such as vector elements from one or more pixel data vectors, scalar values, constants, and/or results from previous processing of vector engine 230 or scalar engine 240, adds a high level of processing flexibility to embodiments of the present invention. For example, multiplexers 271 (e.g., 271a-c), and 272 (e.g., 272a-d), enables the multiplexing of elements to the processing data stream of each vector element processing unit. Multiplexer 271 can also be configured to multiplex constant and scalar values into vectors to be processed in vector engine 230.

Routing infrastructure 220 can also include registers 251 (e.g., 251a-b) and 252 (e.g., 252a-d) in the path of one or both source pixels (also referred to as “source vectors”) A and B. It should be noted that, in the following description, source pixels A, B, and C, can be any data vectors and does not necessarily have to be pixel and/or vertex data. Routing infrastructure 220 can include an arrangement of registers 251 such that elements of data source pixels A, B, and C, encounter differing numbers of registers in its path prior to entry into the respective vector element processing unit. Having elements of source pixels A, B, and C, go through different numbers of registers enables staggering data from the different sources at entry to the respective vector element processing units. For example, an element from a pixel corresponding to a source A can encounter registers 251a followed by one register from 252a-d, and an element from a pixel corresponding to a source B can encounter registers 251b, can be used to delay the input from source A at least one clock cycle relative to the input from source B, and at least two cycles relative to the input from source C.

Also, some embodiments can enable the re-injection of values from one or more source pixels prior to any processing. For example, routing loops 283a and 283b enables the content from registers 251a or 252b, respectively, to be looped back into a corresponding multiplexer 271a or 271b, so that selected pixel elements can be repetitively fed back into the computation stream. This allows constants or other input data to be stored and delivered to several pixels in sequence.

Vector engine 230 comprises a plurality of vector element processing units, for example, four vector element processors 231x, 231y, 231z, and 231w. Each vector element processing unit can comprise one or more registers, and one or more computation units (e.g., 265a-d). The registers include pre computation registers (e.g., 253) and post computation registers (e.g., 254). In some embodiments, the computations units include multiplication and add operations and may be known as multiply and add (MAD) units. It will be understood that MAD units are used by way of example only and vector element processing units can include a wide variety of mathematical and/or logical operators implemented in addition to or in place of MAD units. In the embodiment of 200, for example, each of the computations units 265a-d include four stages of computation 261-264. The computation unit 265a, for example, can have a multiply operator and related registers 261a, shift operator and related registers 262a, an add operator and related registers 263a, and a normalizing operator and related registers 264a.

Each vector element processing unit may include a number of registers and an organization of such registers configured according to selected criteria. For example, vector element processing unit 231w can be configured to have one register 253 in the path before the element values are submitted to the respective MAD unit. Also, in vector element processing unit 231w, the direct path from the output of the respective MAD unit to the results register 257 can include three registers 254a, 255a, and 256a. Vector element processing unit 231 z can be configured to have a 2 registers, 253-d-f and 258a-c, in the path before the element values are submitted to the respective MAD unit, and the direct path from the output of the MAD unit to the results register 257 can include two registers 255b and 256b; vector element processing unit 231y can be configured to have 3 registers, 253g-i, 258d-f and 259a-c, in the path before the element values are submitted to the respective MAD unit, and the direct path from the output of the MAD unit to the results register 257 can include one registers 256c; and vector element processing unit 231x can be configured to have a 4 registers, 253j-l, 258g-i, 259d-f and 260a-c, in the path before the element values are submitted to the respective MAD unit, and have no registers in the direct path from the output of the MAD unit to the results register 257. Configuring each vector element processing unit 231x, 231y, 231z, and 231w, with different numbers of pre and post MAD unit registers enable the exchange of data among the vector element processing units. For example, the additional registers in 231w after the MAD unit, compared to 231x, enables a result from 231x to be multiplexed into the results of 231w. Such forwarding of result values from 231x to 231w may take place over connection 294. It would be understood that staggering the processing within MAD units enables performing complex operations on any given pixel, by enabling a MAD unit that is one or more clock cycles ahead than another MAD unit processing elements from the same pixel vector to forward intermediate results to the latter MAD unit.

Each vector element processing unit may include additional devices such as multiplexers (e.g., 274, 275a-c), shift operators, sign conversion operators (e.g., 269a-l), and normalizing operators. Multiplexers 274 and 275a-c can be configured to select between vector elements in the path of computation in the particular vector element processing unit, and results or intermediate results from adjacent vector element processing units. Shift operators facilitate add operations. Sign conversion operators can be configured to selectively change the sign of one or more vector elements before being input to MAD units. Normalizing operators can be configured to implement any needed normalizing and/or clamping function.

Results register 257, in an embodiment, can hold four vector elements. Results register 257 is written subsequent to processing in vector element processing units. Each vector element can comprise a value computed in the respective vector element processing unit, or a value computed in an adjacent vector element processing unit. The contents of results register 257 can be fed, through routing connection 281 as previous vector (PV) values, into GPR 210, scalar engine 240, and/or one or more of the vector element processing units 231x, 231y, 231z, and 231w.

Scalar engine 240 can be configured to accept input associated with one or more of the pixel sources A, B, or C, along with associated constant values. Scalar engine 240 may be configured such that the input associated with pixels that are concurrently executing in vector engine 230 are staggered and/or pipelined such that any delay related to the synchronization of processing of elements of a particular pixel in scalar engine 240 and vector engine 230 are minimized. Scalar engine 240 can include a scalar operation pipeline through which each scalar value to be processed is directed. In an embodiment, scalar engine 240 can be used for computations involving transcendental functions such as square toot, exponential, and/or trigonometric functions. The input to the scalar pipeline can be configured to provide a predetermined delay among inputs to facilitate the minimization of associated delay. Scalar engine 240 can also be configured to accept and process values from the PV and/or previous scalar (PS). For example, values from PV and PS forwarded to GPR 210 via respective connections 281 or 282 can be multiplexed and/or swizzled through routing infrastructure 220.

A person of skill in the art would recognize that shader 200 would include a controller (not shown) such as a sequencer. For example, a sequencer can control the functionality of routing infrastructure 220, vector engine 230, and/or scalar engine 240. A sequencer may also provide constant and/or scalar values to be used in vector engine 230 and scalar engine 240.

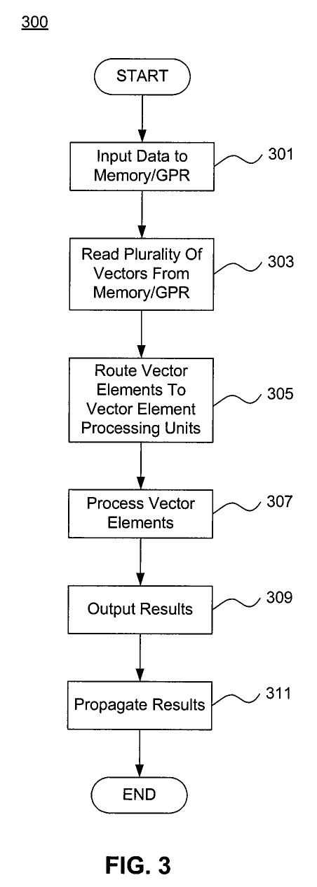

FIG. 3 illustrates a flowchart of steps of a process 300 in processing vectors, such as vertex or pixel data vectors having elements X, Y, Z, and W, according to an embodiment of the present invention. In step 301, data to be processed using a vector engine 230 is input to a memory such as GPR 210, which is associated with vector engine 230. For example, an application executing on CPU 101 can initiate the transfer of a stream of vertex data from system memory 103 to GPU local memory 111 that includes GPR 210. The movement of vertex data can be controlled by a separate DMA controller (not shown). In some embodiments, vector and/or scalar values output by vector engine 230 and/or scalar engine 240 can be re-injected into GPR 210 in order to be incorporated to the vector and/or scalar processing stream again. In inputting the data to the memory the data may be organized to facilitate the read process. For example, data from system memory, previous vector and previous scalar values can be multiplexed on input to GPR 210, GPR registers may be arranged in sets of registers each set corresponding to elements X, Y, Z, and W, of one pixel.

In step 303, a plurality of vectors are read from a memory associated with the vector engine. Command processor 107, for example, during execution of instructions can cause the reading, from GPR 210, of one or more vectors to be processed in vector engine 230. According to an embodiment, during one clock cycle, four register banks may be read. The four register banks may be read to retrieve up to three pixels, plus one vector of export data.

In step 305, pixels and other data retrieved in the previous step are routed to a vector engine, and to a scalar engine, as necessary. For example, routing infrastructure 220 can be configured to direct elements from three source vectors—source A, source B, and source C—to appropriate vector element processing units in vector engine 230 and scalar engine 240. Routing infrastructure 220 can be configured to also route data such as constants associated with one or more of the retrieved source vectors to the vector engine 230 and scalar engine 240. Routing infrastructure 220 can also be configured to route export data out of the shader block to system memory 103. Step 305 can include one or more steps of multiplexing and/or swizzling to direct each input to the desired destination for processing. After multiplexing and swizzling of the source vector elements retrieved from GPR 210, the X, Y, Z, and W, elements of the retrieved source vectors are input to vector element processing units that each may be optimized for processing one or more of the elements.

Step 307 includes the processing of vector elements in each of the vector element processing units. For example, each type of element, such as X, Y, Z, and W elements of a pixel, is processed in vector element processing units that can be configured according to the particular characteristic of that element in a pixel. X, Y, Z, and W elements, for example, can be processed in vector element processing units 231x, 231y, 231z, and 231w, respectively. Processing in each of the vector element processing units can include one or more multiply operations and one or more add operations.

The processing of X, Y, Z, and W elements in the respective vector element processing units can be staggered such that the results from processing one element of a pixel can be made available for the processing of another element of the same or other source vector. For example, as described above in relation to vector engine 230 in FIG. 2, the number and arrangement of registers within each vector element processing unit 231x, 231y, 231z, and 231w, can be varied in order to enable the sharing of intermediate and final results between vector element processing units.

In step 309, the values output from each of the vector element processing units are written to a vector register, such as register 257. In step 311, the results written in vector register 257 can be provided to another stage (not shown) of processing data, or can be made available for re-injection in to the processing stream of the vector engine 230 by routing to the vector to GPR 210 through routing connection 281.

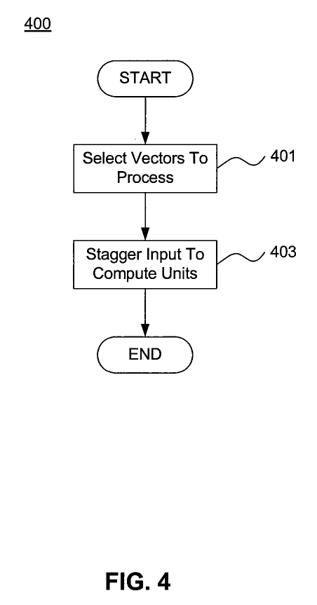

FIG. 4 illustrates a flowchart of steps 401-403 that can be used in an embodiment to implement a step 305 of process 300. Steps 401-403 refer primarily to configuring the routing infrastructure, such as routing infrastructure 220, to select source vector elements and to input source vector elements for the appropriate vector element processing units. In step 401, the source vectors to be processed are selected and also any constant values to be simultaneously used are selected. For example, a predetermined number of sets of registers from GPR 210 can be identified where each set of registers can include up to four vector elements. On each clock cycle, the predetermined number of the sets of registers can be read to retrieve up to 3 separate source vectors plus constant data. A fourth vector plus constant data can be selected for export to system memory 103 on each clock cycle.

In step 403, the input selected from GPR 210 and/or any input available from another memory, is directed through the routing infrastructure 220 to the appropriate vector element processing unit. For example, multiplexers 221 and swizzle units 222 can be configured to direct source pixels A, B, and C, as needed. Then, multiplexers 271, 272, and 273 can be configured to direct X, Y, Z, and W components of each of the source pixels A, B, and C, as well as constant values and/or previous vector and/or scalar values for processing in the respective vector element processing units. For example, X can be directed to 231x, Y can be directed to 231y, Z can be directed to 231z, and W can be directed to 231w. X elements from source C can be routed through multiplexer 271c directly to multiplexer 272d with no intervening registers; X elements from source B can be routed through multiplexer 271b, register 251b to multiplexer 272d with one intervening register; and the X element from source A can be routed through multiplexer 271a, registers 251a and 252d to multiplexer 272d with no intervening registers. Thus, the X elements from sources A, B, and C, encountered 2, 1, and 0, respectively, of registers between the time the value being output from multiplexer 271 and reaching the multiplexer 272 of the vector element processing unit. It should be understood that having differing number of registers in the path of data generally consumes differing amounts of clock cycles to get the elements from sources A, B, and C to the vector element processing unit. Therefore, in general, the X, Y, Z, and W components of a vector can be staggered upon its entry to the respective vector element processing units.

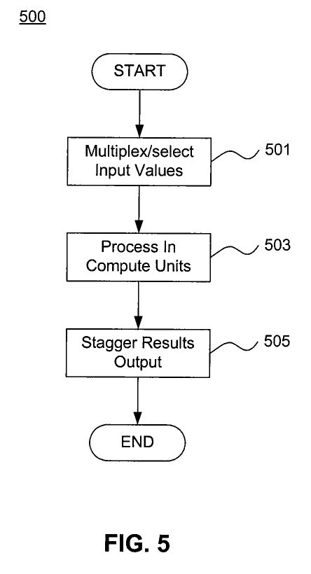

FIG. 5 illustrates steps 501-505 that can be used in implementing the processing step 304 of process 300, according to an embodiment. In step 501, subsequent to the routing step 303, input values are received at the MAD unit of each vector element processing unit. For example, X values from source pixels A, B, and C, can be available to be processed in the MAD unit of vector element processing unit 231x; Y values from source pixels A, B, and C, can be available to be processed in the MAD unit of vector element processing unit 231y; Z values from source pixels A, B, and C, can be available to be processed in the MAD unit of vector element processing unit 231z; and W values from source pixels A, B, and C, can be available to be processed in the MAD unit of vector element processing unit 231w.

In step 503, processing is commenced upon the data loaded into the input registers of the MAD unit in each vector element processing unit. The processing in one or more of the MAD units can include a multiply operation followed by an add operation. Between the multiply and add operations, one or more other mathematical manipulations, such as, shift operators can be available to the data being processed. Intermediate results can be stored in one or more registers, and can also be forwarded to one or more other vector element processing units. The resulting values can be subjected to further mathematical operations such as normalizing.

In step 505, the resulting values are written to an output vector register, such as results vector 257, after proceeding through none, one or more intermediate registers. In an embodiment, as in FIG. 2, each vector element processing unit can be configured to have none, one or more registers in the path from the output from the MAD unit to the results vector register. Having different numbers of intermediate registers between the MAD and results vector register in each vector element processing unit facilitates the forwarding of results from one vector element processing unit to another. Each register in the path from the MAD output in the vector element processing unit to the results vector can, in some embodiments, delay the writing of the result of the vector element processing unit by one or more clock cycles. By the use of registers to delay or stagger the writing of the output, results from one vector element processing unit can be forwarded to the results path of another vector element processing unit. A result forwarded to the results path of a neighboring vector element processing unit can be multiplexed into the results path.

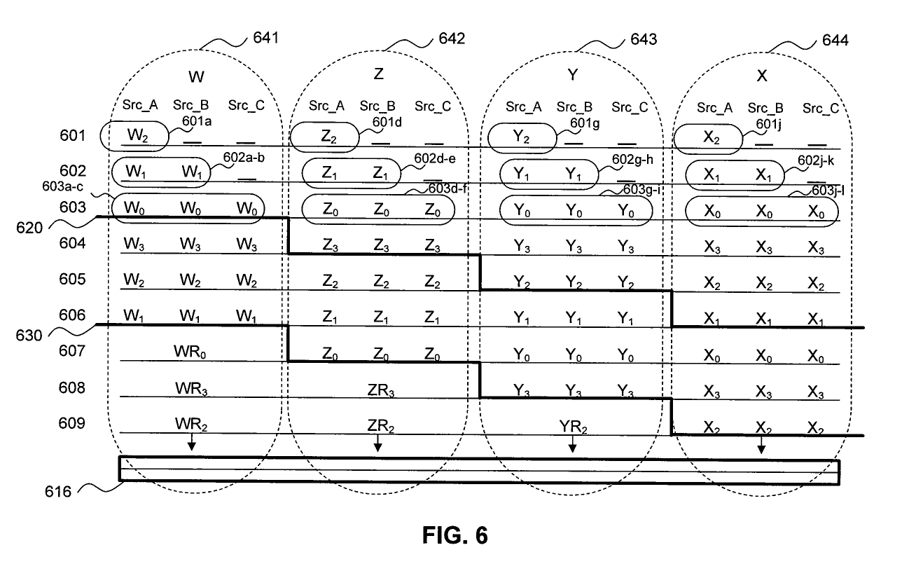

FIG. 6 is illustrative of how vector elements, for example, source pixels A, B, and C, can flow through the vector element processing units of a vector engine, according to an embodiment of the present invention. It is convenient to describe FIG. 6 in relation to FIG. 2. FIG. 6 illustrates an instant in time during the processing of an application, where all registers shown in FIG. 2 in the data path between GPR bank 210 and results vector 257 associated with vector engine 230 are occupied with data. Each source pixel can have elements X, Y, Z, and W, each of 32 bits. The first, second, and third columns of 641, 642, 643, and 644, represent the flow of pixels corresponding to source pixels A, source pixels B, and source pixels C through vector element processors 231w, 231z, 231y, and 231x, respectively. Elements 601a, 601d, 601g, and 601j, correspond to the source pixel A stored in register 251a. For example, all elements of source pixel A are written to register 251a before each of the elements X, Y, Z, and W are separately written to registers 252a, 252b, 252c, and 252d. More specifically, in one clock cycle X2, Y2, Z2, and W2 are stored in register 251; in the next clock cycle, the four elements X2, Y2, Z2, and W2 are separately written to registers 252a, 252b, 252c, and 252d. The values in registers 252a, 252b, 252c, and 252d are represented by 601a, 601d, 601g, and 601j. In the path of source pixel B, elements 602b, 602e, 602h, and 602k correspond to the 128 bit register 251b that holds source pixel B that comprises X1, Y1, Z1, and W1. Elements 603a-603c, 603d-603f, 603g-603i, and 603j-603l, correspond to values stored in respective registers 253. For example, 653a-653c are stored in registers 253a-253c, 603d-603f in 253d-253f, 603g-603i in 253g-253i, and 603j-603l in 253j-253l. It should be noted that the W elements of the source pixels A, B, and C are directly written to the corresponding MAD from register 253, while Z, Y, and X elements, are delayed by one, two, and three clock cycles, respectively, if each intermediate register in the path of the data delays the data by one clock cycle. With respect to the source pixels, source pixel A encounters more registers relative to source pixel B prior to being written to the 253 register.

The lines 620 and 630 are illustrative of the logical entry and exit points to the MAD in each of the vector element processing units. Registers 253, 258, 259, and 260, are vector registers holding the element values immediately prior to being subjected to processing in the respective MAD units in vector element processing units 231w, 231z, 231y, and 231x, respectively. Vector element processing units 231w, 231z, 231y, and 231x, have none, one, two, and three registers, respectively, between the 253 register and the respective MAD unit. Having different numbers of registers in the data paths corresponding to each vector element processing unit enables the submission of data and results from the same pixel to respective MAD units in a staggered manner. The staggering of the elements from the same pixel on input to the respective MAD units facilitate the forwarding of intermediate results from the MAD unit of one vector element processing unit to another vector element processing unit. For example, as indicated by the line 620, W elements in vector element processing unit 231w enter the MAD unit first, and therefore can forward intermediate results, such as multiply and add results, to other vector element processing units. Forwarding paths 291 and 292 in FIG. 2 are illustrative of the capability to forward intermediate results from the MAD unit of vector element processing unit 231 w to the vector element processing unit 231z.

In the example shown in FIG. 6, the MAD units all have the same number of registers in their data paths. For example, 641, 642, 643, and 644, each has 3 registers between lines 620 and 630. It should be understood, however, that each MAD can include differing numbers and types of registers and operations, and still be consistent with the teachings of this disclosure.

On output from each MAD unit, the data path of 641, 642, 643, and 644, each has a different number of registers before being written to results vector 257. As shown, 641 (i.e., data path corresponding to 231w) has 3 registers in its data path before a result is written to the corresponding result vector. 642, 643, and 644, respectively, have two, one, and no registers in the data path between the output from the MAD unit and the corresponding results vector registers. The differing number of registers in the data path between the output from the MAD unit to the result vector in each vector element processing unit enables the results to be forwarded between vector element processing units. For example, because vector element processing unit 231w, also as shown in 641, is configured with three registers between the output of the MAD unit and the results register, it can take four clock cycles after the results are output from that MAD unit for those results to be written into the corresponding results register. Vector element processing unit 231x, however, has no intermediate registers between the MAD output and the results register. Therefore, the result from vector element processing unit 231x can be multiplexed into the data path of the results of vector element processing unit 231w. Forwarding path 294 illustrates the capability for 231x to forward its result to other vector element processing units. Other forwarding capabilities for results may be provided between vector element processing units. Forwarding path 293 illustrates the capability for vector element processing unit 231z to forward its result to vector element processing unit 231w. This can be useful, for example, for double precision operations and/or double precision multiply operations.

The embodiments described above can be described in a hardware description language such as Verilog, RTL, netlists, etc. and that these descriptions can be used to ultimately configure a manufacturing process through the generation of maskworks/photomasks to generate one or more hardware devices embodying aspects of the invention as described herein.

Embodiments of the present invention yield several advantages over previously known vector processing engines. As noted earlier, previously known vector engines in GPUs processed pixel data one pixel to a vector processor, whereas in the present invention each vector element processing unit processes an element of a pixel vector. Embodiments of the present invention can yield substantial reductions in the required logic and die-space to implement more flexible functionality. Because each vector element processing unit now processed one type of element many advantages can result, such as: each vector element processing unit can use smaller registers for input and output, multiplexers can be laid out better saving logic and space, the requirements of constants made available to each vector processor can be reduced, and power savings can result from having each computation unit process the same opcode on several pixels in series. Also, the present invention enables the integrated processing of vector and scalar data, for example, by facilitating constants and scalar values to be multiplexed into vectors to be processed in the vector engine.

### CONCLUSION

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A vector processing system, comprising:
a plurality of vector element processing units; and
a routing infrastructure configured to route each element of a received vector to a respective one of the vector element processing units.

2. The vector processing system of claim 1, wherein the routing infrastructure is further configured to simultaneously route corresponding elements of two or more vectors to respective vector element processing units.

3. The vector processing system of claim 1, wherein at least one of the vector element processing units is configured to:
simultaneously process two or more elements, wherein each of the two or more elements is from a separate vector.

4. The vector processing system of claim 3, wherein the at least one of the vector element processing units is further configured to:
route the two or more elements through one or more pre computation unit registers to a computation unit; and
process the two or more elements in the computation unit.

5. The vector processing system of claim 4, wherein the at least one of the vector element processing units is further configured to:
route the two or more elements from the computation unit through one or more post computation unit registers to a results register.

6. The vector processing system of claim 4, wherein a first and a second one of the vector element processing units comprise respectively a first number of said pre computation unit registers and a second number of said pre computation unit registers, wherein the first number is higher than the second number.

7. The vector processing system of claim 6, wherein the first and the second one of the vector element processing units comprise respectively a third number of said post computation unit registers and a fourth number of said post computation unit registers, wherein the fourth number is higher than the third number.

8. The vector processing system of claim 4, wherein the at least one of the vector element processing units is further configured to:
forward values from the computation unit to a second vector element processing unit.

9. The vector processing system of claim 1, wherein the routing infrastructure comprises:
a plurality of multiplexers;
one or more swizzle units; and
a plurality of registers, wherein each one of the registers is directly or indirectly coupled through one or more of said multiplexers to at least one of the swizzle units and to at least one of the vector element processing units.

10. The vector processing system of claim 9, wherein the plurality of multiplexers and the one or more swizzle units are configured to substitute one or more elements of a vector with a substitute value.

11. The vector processing system of claim 1, wherein the routing infrastructure is further configured to:
route a first and second vector to respective said vector element processing units such that elements from the first vector and the second vector are routed through, respectively, a first set of registers and a second set of registers, wherein the first set of registers comprises a greater number of registers than the second set of registers.

12. The vector element processing system of claim 1, further comprising:
a results vector register coupled to the plurality of vector element processing units, wherein the values from the results vector register are forwarded to a memory.

13. The vector element processing system of claim 12, wherein the values from the results vector register are forwarded to at least one of the vector element processing units.

14. The vector element processing system of claim 1, wherein the vector comprises pixel data.

15. The vector element processing system of claim 1, wherein the routing infrastructure is further configured to couple at least one memory to the plurality of vector element processing units.

16. The vector element processing system of claim 15, wherein the at least one memory comprises general purpose registers of a graphics processing unit.

17. A method of processing a plurality of vectors, comprising:
routing each element of one of the vectors to respective vector element processing units;
processing said each element in said respective vector element processing units; and
outputting, based on said processing, at least one result from said respective vector element processing units.

18. The method of claim 17, wherein the processing comprises:
staggering entry of a first element and a second element from said one of the vectors to computation units in a first and a second one of said respective vector element processing units by one or more clock cycles.

19. The method of claim 18, wherein the processing further comprises:
forwarding an intermediate result from the first one of said respective vector element processing units to the second one of said respective vector element processing units.

20. The method of claim 17, wherein the outputting comprises:
staggering writing of the at least one result from a first and a second one of said respective vector element processing units to a results vector by at least one clock cycle.

21. The method of claim 20, wherein the outputting further comprises:
forwarding a result from the first vector element processing unit to the second vector element processing unit.

22. The method of claim 20, further comprising:
providing a value from the results vector to a memory, wherein said plurality of vectors is stored in the memory.

23. The method of claim 17, wherein the vector comprises pixel data.

24. A computer readable media storing instructions wherein said instructions when executed are adapted to process a plurality of vectors by comprising:
route each element of one of the vectors to respective vector element processing units;
process said each element in said respective vector element processing units; and
output, based on said processing, at least one result from said respective vector element processing units.

25. The computer readable media of claim 24 wherein said instructions comprise hardware description language instructions.

26. The computer readable media of claim 24 wherein said instructions are adapted to configure a manufacturing process through the generation of maskworks/photomasks to generate a device for processing said plurality of vectors.
